(19) United States
(12) Patent Application Publication
(10) Pub. No.: US 2009/0323270 A1
(43) Pub. Date: Dec. 31, 2009

(54) Portable Hard Disk

(76) Inventor: Kai LI, Shenzhen City (CN)

Correspondence Address: Muncy, Geissler, Olds & Lowe, PLLC, P.O. BOX 1364, FAIRFAX, VA, 22038-1364, US

(21) Appl. No.: 12/490,865

(22) Filed: Jun. 24, 2009

(30) Foreign Application Priority Data
Jun. 25, 2008 (CN) 200810068032.X

(51) Int. Cl. G06F 1/16

(52) U.S. Cl. 361/679.33

(57) ABSTRACT

A portable hard disk includes a housing, an opening on the housing, a movable USB male connector pulled out of the housing through the opening, a hard disk and a flexible printed circuit board electrically connected with the hard disk, the hard disk and the flexible printed circuit board being collected inside the housing. The soft printed circuit board includes a hard disk control chip, a circuit and a thin extension portion as a USB data line to connect with the USB male connector. The USB data line is bended and collected inside the housing and is pulled out of or pushed into the housing, along with the USB male connector which is a movable structure and is collected inside the housing. Upon using, the USB male connector is pulled out of the opening and is connected through the flexible USB data line which is not broken and damaged easily.

### BACKGROUND OF THE INVENTION

a) Field of the Invention

The present invention relates to a portable hard disk, and more particularly to a portable hard disk which is provided with a movable USB (Universal Serial Bus) male connector.

b) Description of the Prior Art

As continuous development of technologies and gradual popularity of computer technology, portability and convenience in carrying have become two major subjects in the field of computer hardware. Therefore, a portable hard disk arises and is used broadly due to a small size, light weight, simplicity in use and convenience in carrying. To facilitate data transmission, most of conventional portable hard disks use a USB male connector to connect with a computer and there are usually two ways for provision of the USB male connector. One is to use an external connection wire with the USB male connector to connect the portable hard disk with the computer. However, this method is not convenient and the connection wire can be easily forgotten or lost. The other method is that the portable hard disk is provided with the USB male connector by itself and therefore, it is more convenient to use than the previous one. Yet, as the USB male connector is exposed out of a housing of the portable hard disk, space can be occupied, the USB male connector can be damaged easily and overall beautifulness can be affected.

### SUMMARY OF THE INVENTION

The primary object of the present invention is to provide a portable hard disk which is provided with a movable USB male connector that the USB male connector is pulled out to be connected with a computer while in use and is pushed back into a holding slot of the portable hard disk when not in use, so that the USB male connector can be located inside a housing of the portable hard disk to facilitate carrying and using.

Accordingly, a portable hard disk of the present invention includes a housing, an opening on the housing, a movable USB male connector which is pulled out of the housing through the opening, a hard disk and a flexible printed circuit board which is electrically connected with the hard disk, with the hard disk and the flexible printed circuit board being collected inside the housing. The soft printed circuit board is provided with a hard disk control chip and a circuit and includes a thin extension portion which serves as a USB data line to connect with the USB male connector. The USB data line is bended to be collected inside the housing and is pulled out of or pushed into the housing, along with the USB male connector.

The effects of the present invention first lie in that the housing is collected with the hard disk, the USB male connector is electrically connected with a hard disk data port through the flexible printed circuit board, the housing is provided with the opening and an interior of the housing is provided with the holding slot corresponding to the opening, so that for the USB male connector, a conventional fixed structure is changed to a movable structure. Upon using, the USB male connector is pushed out of the opening; while not in use, the USB male connector is pushed back into the holding slot of the housing. The USB male connector is connected with the flexible printed circuit board through the USB data line which is a flexible data line, thus it will not be easily broken or damaged when being constantly bended or extended. In addition, the USB data line is provided with a certain length that a length by which the USB male connector is pushed out can be adjusted. Secondly, the flexible printed circuit board design facilitates compactness of the device. On the other hand, as the flexible printed circuit board for hard disk control and the USB data line are one-piece designs, production efficiency is improved. Moreover, as the USB male connector is an unshielded design, space can be saved and an entire portable hard disk structure can be simplified as well as can be carried and used conveniently.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional perspective structure view of a portable hard disk of the present invention.

FIG. 2 shows a schematic unfolded view of an interior of FIG. 1.

FIG. 3 shows a schematic view of a connection structure between a USB male connector and a flexible printed circuit board in FIG. 2.

FIG. 4 shows a schematic view of a usage state of FIG. 1.

### DETAILED DESCRIPTION OF THE PREFERRED EMBODIMENTS

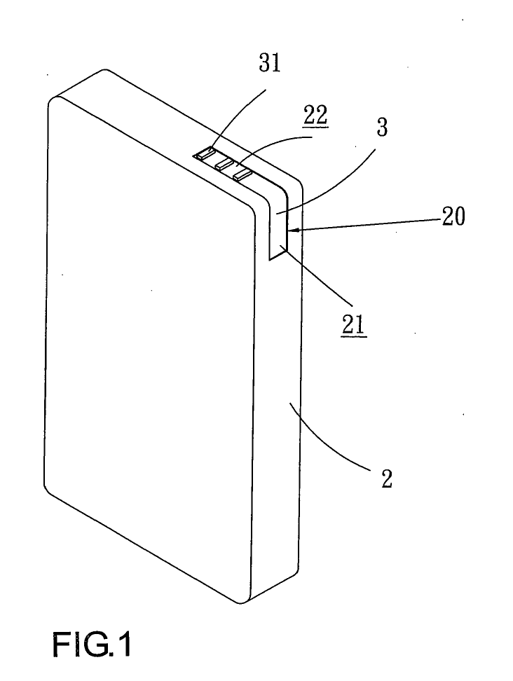

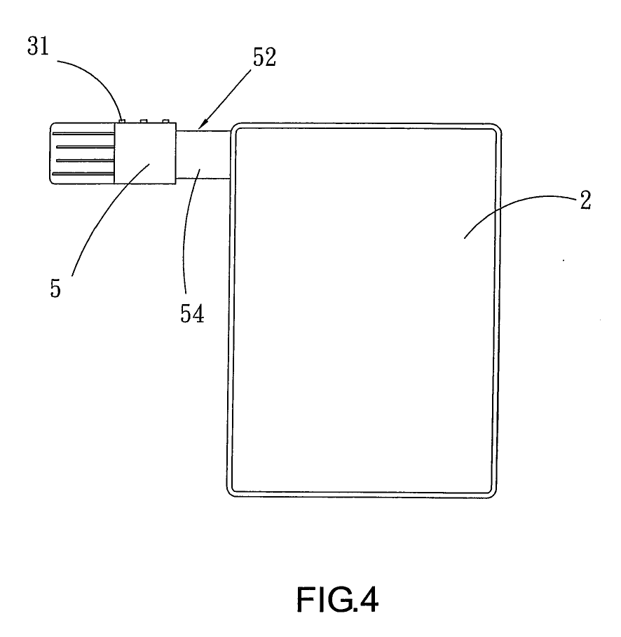

Referring to FIGS. 1 to 4, a portable hard disk of the present invention comprises a housing 2, an opening 20 which is provided on the housing 2, a movable USB male connector 3 which is pulled out of the housing 2 through the opening 20, a hard disk 4 and a flexible printed circuit board 5 which is electrically connected with the hard disk 4, with the hard disk 4 and the flexible printed circuit board 5 being collected inside the housing 2. The soft printed circuit board 5 includes a hard disk control chip 51 and a circuit (not shown in the drawings), and is provided with a thin extension portion which serves as a USB data line 52 to connect with the USB male connector 3. The USB data line 52 is bended to be collected inside the housing 2 and is pulled out of or pushed into the housing 2, along with the USB male connector 3.

The aforementioned housing 2 includes a lower housing 23 and an upper housing 24 which fits with the lower housing 23. An interior of the lower housing 23 is divided into a containing cavity 25 for collecting the hard disk 4 and a holding slot 26 for collecting the USB male connector 3 and the USB data line 52. Two side walls of the aforementioned opening 20 at a corner of the lower housing 23 are connected with a first rabbet 21 and a second rabbet 22. The first rabbet 21 is provided at an end of the holding slot 26 and the second rabbet 22 is provided on a side wall of the holding slot 26. The holding slot 26 corresponds to and is connected with the opening 20, and the USB male connector 3 is pulled out of or pushed into the holding slot 26 through the opening 20. In addition, an exterior wall of the USB male connector 3 is provided with plural bumps 31 which correspond with the second rabbet. 22 to facilitate taking out the USB male connector 3. It is worthy of mentioning that the USB male connector 3 is not provided with a shielded outer housing and can be directly inserted into a USB port of an external computer (not shown in the drawings). On the other hand, a lower end surface of the USB male connector 3 is provide with a chute 32 along a length of the USB male connector 3, and an end of the chute 32 is extended to a rear end surface of the USB male connector 3. An end of the aforementioned holding slot 26 toward the USB male connector 3 is provided with a fixing block 28, an inner wall of which is provided with a guide rail (not shown in the drawings) corresponding to the chute 32. The USB male connector 3 is pushed into or pulled out of the holding slot 26 along the guide rail, enabling the USB male connector 3 to have good directionality.

The hard disk control chip 51 of the flexible printed circuit board 5 can use an existing chip to process data transmitted between the USB male connector 3 and the hard disk 4. In the present embodiment, the hard disk control chip 51 is a GL811S chip which consumes less electricity and is provided with lower temperature and fewer pins. The flexible printer circuit board 5 is fixed on the upper housing 24 through sticking and a side of the flexible printed circuit board 5 toward the hard disk 4 is provided with a bus port 53 which corresponds to a data port (not shown in the drawings) on the hard disk 4. The flexible printed circuit board 5 is electrically connected with the data port of the hard disk 4 through the bus port 53, and the data port can be a ZIF (Zero Insertion Force) port to connect with periphery equipment (not shown in the drawings) without using a decoder chip, which enables the portable hard disk to have better practicability.

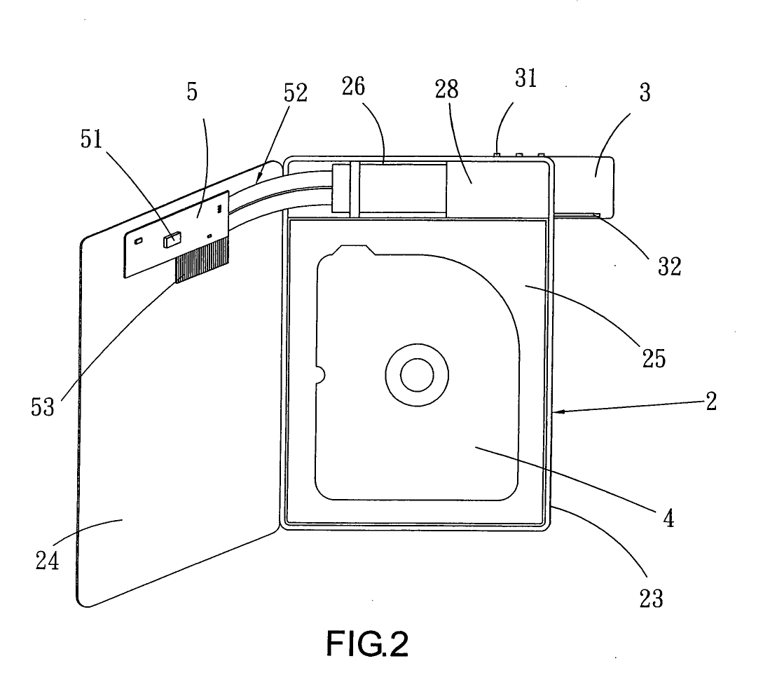

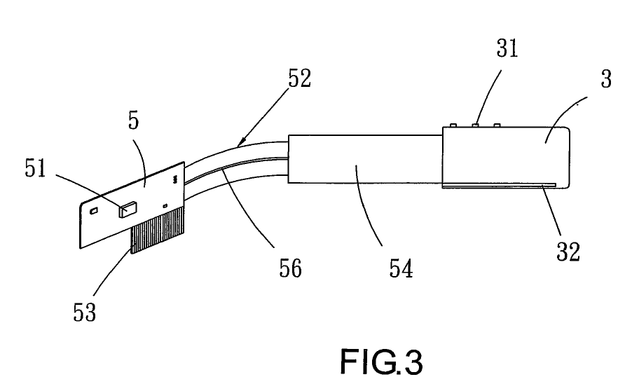

Referring to FIGS. 2 and 3, the USB data line 52 of the flexible printed circuit board 5 is a flexible data line, which will not be damaged by bending or stretching. The flexible printed circuit board 5 is connected with the USB male connector 3 through the USB data line 52, and an end of the USB data line 52 close to the USB male connector 3 is a guiding part 54 on which is enclosed by a rubber sheath made by silicon, thus having better wear resistance and flexibility. A length of the guiding part 54 can be dependent upon a length by which the USB male connector 3 is pulled. The other end of the USB data line 52, on the other hand, is a stretching part 56. While not in use, the guiding part 54 of the USB data line 52 is collected inside the holding slot 26 of the lower housing 23, and the stretching part 56 is bended to be connected between the guiding part 54 and the flexible printed circuit board 5.

Referring to FIGS. 1 to 4, upon using, the bumps 31 of the USB male connector 3 are pushed out toward the first rabbet 21 along the second rabbet 22, the chute 32 is removed along the guide rail of the lower housing 23, and the USB male connector 3 is exposed out of the housing 2, with a length by which the USB male connector 3 is pulled out being controlled when necessary. In addition, part of the guiding part 54 of the USB data line 52 can be pulled out when necessary, and the stretching part 56 of the USB data line 52 is stretched following that the USB male connector 3 is pulled out, such that the USB male connector 3 can be connected with an external computer which performs data exchange with the hard disk 4 through electrical connection between the USB male connector 3 and the flexible printed circuit board 5. While not in use, the USB male connector 3 is pushed into the holding slot 26 again through the opening 20, which facilitates storing the USB male connector 3 and effectively saves space of the portable hard disk.

Concluding from the above and in accordance with the present invention, the explicit effects first lie in that the interior of the housing is collected with the hard disk, the USB male connector is electrically connected with the hard disk data port through the flexible printed circuit board, the housing is provided with the opening and the interior of the housing is provided with the corresponding holding slot, so that for the USB male connector, a conventional fixed structure is changed to a movable structure. Upon using, the USB male connector is pushed out of the opening; while not in use, the USB male connector is pushed back into the holding slot of the housing. The USB male connector is connected with the flexible printed circuit board through the USB data line which is the flexible data line that it will not be broken or damaged easily when being constantly bended or stretched. In addition, the USB data line is provided with a certain length that the length by which the USB male connector is pushed out can be adjusted. Secondly, the flexible printed circuit board design facilitates the compactness of the device. Moreover, as the flexible printed circuit board for hard disk control and the USB data line are one-piece designs, production efficiency is improved. On the other hand, as the USB male connector is an unshielded design, space can be saved and the entire portable hard disk structure can be simplified as well as can be carried and used conveniently.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A portable hard disk comprising a housing, an opening on the housing, a movable USB (Universal Serial Bus) male connector which is pulled out of the housing through the opening, a hard disk and a flexible printed circuit board which is electrically connected with the hard disk, with the hard disk and the flexible printed circuit board being collected inside the housing; the soft printed circuit board including a hard disk control chip and a circuit and being provided with a thin extension portion which serves as a USB data line to connect with the USB male connector; the USB data line being bended to be collected inside the housing and being pulled out of or pushed into the housing, along with the USB male connector.

2. The portable hard disk according to claim 1, wherein two side walls of the opening at a corner of the housing are connected with a first rabbet and a second rabbet, an interior of the housing corresponding to the opening is provided with a holding slot to collect the USB data line and the USB male connector, with the holding slot being connected with the opening.

3. The portable hard disk according to claim 2, wherein an exterior wall of the USB male connector is provided with plural bumps which correspond to the second rabbet to facilitate taking out the USB male connector.

4. The portable hard disk according to claim 2, wherein the USB male connector is provided with a chute and a wall of the holding slot is provided with a guide rail corresponding to the chute.

5. The portable hard disk according to claim 1, wherein the USB male connector is not provided with a shielded outer housing.

6. The portable hard disk according to claim 2, wherein the housing includes a lower housing and an upper housing which fits with the lower housing, the holding slot is provided in the lower housing, and an interior of the lower housing is provided with a containing cavity to collect the hard disk, with the containing cavity being separated with the holding slot.

7. The portable hard disk according to claim 1, wherein the flexible printed circuit board is fixed on the housing through sticking, a side of the flexible printed circuit board toward the hard disk is provided with a bus port which corresponds to a data port on the hard disk, and the flexible printed circuit board is electrically connected with the data port of the hard disk through the bus port.

8. The portable hard disk according to claim 7, wherein the data port on the hard disk is a ZIF (Zero Insertion Force) port.

9. The portable hard disk according to claim 1, wherein the hard disk control chip on the soft printed circuit board is a GL811S chip.

10. The portable hard disk according to claim 2, wherein an end of the USB data line close to the USB male connector is a guiding part on which is enclosed by a rubber sheath and which is collected inside the holding slot of the housing, and the other end of the USB data line is a stretching part.

11. The portable hard disk according to claim 10, wherein the USB data line is a flexible data line.
